(19) United States
(12) Patent Application Publication
(10) Pub. No.: US 2011/0133617 A1
(43) Pub. Date: Jun. 9, 2011

(54) DAMPER FOR PARTS OF A FURNITURE FITTING AND/OR FURNITURE PARTS WHICH CAN BE MOVED RELATIVE TO ONE ANOTHER

(76) Inventor: Bernhard KRAMMER, Hochst (AT)

(21) Appl. No.: 13/027,515

(22) Filed: Feb. 15, 2011

Related U.S. Application Data
(63) Continuation of application No. PCT/AT2009/000328, filed on Aug. 25, 2009.

(30) Foreign Application Priority Data
Aug. 27, 2008 (AT) A 1328/2008

(51) Int. Cl. A47B 95/00; E05D 11/10; A47B 88/04

(52) U.S. Cl. 312/319.1; 16/404; 16/319

(57) ABSTRACT

Furniture fitting with a damper, wherein the damper has a space for accommodating a damping medium, wherein the space is filled substantially completely with a multiplicity of solid particles, and wherein the interspaces remaining between the solid particles are filled substantially completely by a liquid.

The present invention relates to a furniture fitting comprising a damper, wherein the damper has a space for accommodating a damping medium.

In the case of damping media in accordance with the state of the art—such as for example in the case of low-viscosity silicone oils—there is the considerable danger that, because of their relatively low-viscosity consistency, those damping media can run out of the damper housing and also cause massive damage due to the escaping oil, besides making the damper functionally ineffective. In addition the use of low-viscosity damping media is problematical insofar as often they can only generate an inadequate damping effect in small spaces (particularly in shearing gaps with a small filling quantity). If media of high viscosity are used instead of low-viscosity damping media, that also gives rise to the problem that an actuating element associated with the damper can only be moved or restored with difficulty, by virtue of the high viscosity of the damping medium. Thus, when using high-viscosity damping media, that does not always ensure an exemplary damping process as the movable furniture part can be moved only very slowly or not at all, due to the damping force generated. In addition it has been found that the damping characteristic of high-viscosity damping media is frequently heavily temperature-dependent so that the damper also provides a differing damping action at different ambient temperatures.

A damper of the general kind set forth is described in WO 2008/083417 A1 to the present applicant. The damping medium used can be silicone oils and in particular also dilatant medium or fluid, the viscosity of which increases with a rising shearing speed.

Dampers which are not in accordance with the general kind set forth are described for example in AT 40052 and U.S. Pat. No. 1,114,691. Those dampers each involve shock absorbers for vehicles comprising a vane which is rotatable in a housing and which is completely immersed in a friction material. The friction material used can be mixtures of mountain chalk and water as well as plastic clay materials. In that case, similarly to a mixer, the rotatable vane must carve a path through the resistance material, a uniform friction being produced for damping the vehicle spring oscillations. With those dampers a large amount of damping medium has to be moved in order to absorb the high forces occurring in a shock absorber. Therefore the structural space required by such dampers is also correspondingly great. The spacing remaining between the free end of the rotatable vane and the inside wall of the housing must be relatively large to prevent the friction material moving as a whole with the vane. For that purpose it is also provided that the inside wall is roughened up.

The object of the present invention is to provide a damper of the general kind set forth, avoiding the above-indicated disadvantages.

In an advantageous configuration in accordance with the invention that is achieved in that the space is substantially completely filled with a multiplicity of solid particles, wherein the intermediate spaces remaining between the solid particles are substantially completely filled by a liquid.

The damping medium formed thereby, in the rest condition—at ambient temperature and without pressure acting thereon—is in an almost pasty condition so that overall this involves a material which is substantially not capable of flow. Flow capability is brought about by an increase in temperature and/or by the action of pressure thereon. The damping medium is therefore desirably heated when filling the damper so that the filling operation is possible without any problem. During the damping process in contrast shearing forces act on the damping medium, and they produce the required flow capability and thus a damping action. The damping action is primarily brought about by solid body friction, wherein the liquid which is present in a relatively low concentration is provided for the transmission of moment between the moving solid particles. It is possible in that way to implement dampers in which the risk of the damping medium escaping is substantially reduced. That therefore also reduces the sealing problems which frequently occur in the state of the art, when using damping media of relatively low viscosity. In addition the solid body friction provided makes it possible to implement a damper which ensures a substantially homogenous damping characteristic in a temperature range which is usually provided for the purpose of use (for example between 0° C. and 40° C.).

In accordance with an aspect of the invention therefore the damping medium becomes operative in that the solid particles interact by way of a frictional effect. Unlike the situation with a suspension therefore it is not sufficient for the space to be only partially filled with solid particles. According to the invention the solid particles are arranged in substantially tightly packed relationship so that the surfaces of the solid particles are in contact. The intermediate spaces remaining between the solid particles arranged in tightly packed relationship are filled with the liquid.

Further advantageous configurations of the invention are defined in the appendant claims.

The liquid used in this case should be of relatively high viscosity to achieve advantageous results (for example with a kinematic viscosity of 37.5 mm²/s at 40° C.), substantially temperature-resistant (at least within a temperature range of between 0° C. and 40° C.) and should have a relatively high shearing stability (for example 0% in accordance with ASTM D 2603). The shearing stability of the liquid describes its resistance to a permanent loss in viscosity due to the “shearing” of long-chain polymers. Particularly in the event of a mechanical loading in close spaces, the liquid can suffer an unwanted loss in viscosity.

The viscosity of the liquid is generally dependent on temperature. When the temperature of the liquid is increased its viscosity generally falls, while upon a reduction in temperature the viscosity of the liquid generally increases. In that connection the expression “viscosity index” (abbreviated to VI) is frequently used. The viscosity index is a dimensionless number indicating the degree of the change in viscosity within a predetermined temperature range. A high VI therefore characterizes a liquid which exhibits a relatively small change in viscosity with temperature. It can desirably be provided that the liquid has a viscosity index of at least 150, preferably between 200 and 350. The liquid can also be characterized by a VI of greater than 350.

In a preferred embodiment the liquid used is a polymer, preferably an ethylene-α-olefin copolymer, wherein the ethylene content is in the range of between about 40 mol % and about 85 mol %, preferably between 45 mol % and about 55 mol %. As an example of such a copolymer mention may be made of Lucant® HC-600 or Lucant® HC-2000 from Mitsui Chemicals Co. Ltd. which represent hydrocarbon-based oils suitable for that purpose. Those oils have good resistance in relation to temperature fluctuations, while their viscosity is substantially stable in a temperature range which is usual for the purpose of use. Those transparent oils are also chemically stable, thereby substantially reducing the risk of metal corrosion.

Some properties of Lucant ® HC-2000 from Mitsui
Chemicals Co. Ltd. are set forth in the following Table:

| Property | Unit | Test method | Test condition | HC 2000 |
|---|---|---|---|---|
| appearance | — | — | visual | transparent |
| relative density | — | Anton Paar | d²⁰₄ | 0.850 |
| | | density | | |
| | | measurement | | |
| kinematic | mm²/s | JIS K 2283 | 40° C. | 37,500 |
| viscosity | | | | |
| viscosity index | — | JIS K 2283 | | 300 |
| viscosity | mPa · s | ASTM D 2983 | 0° C. | 200 |
| (Brookfield) | (×10⁴) | | | |
| pour point | ° C. | JIS K 2269 | | −5.0 |
| shearing | % | ASTM D 2603 | circulating cold | 0 |
| stability | | | water, 40° C., | |
| | | | 10 KC, 100 W | |
| | | | (30 min.) | |

It should be noted that the foregoing details of Lucant® HC-2000 can represent only a possible embodiment by way of example of the invention. The liquid used for filling the intermediate spaces remaining between the solid particles can also be formed by an alternative liquid, the properties of which can differ from the information set out in the foregoing Table.

In accordance with a preferred embodiment of the invention it is provided that the solid particles are of a substantially spherical configuration. In this connection the term “form factor” is frequently used, which characterizes a measurement in respect of the form of an irregularly formed particle. The invention can be implemented in particularly advantageous fashion if the balls used as the solid particles have a form factor of between 0.5 and 1, preferably substantially 1. To ascertain the form factor it is possible to refer to “Wadell's sphericity”, whereby the sphericity of the solid particles is defined as the ratio of the surface area of a ball of the same volume to the actual surface area:

$$F = \frac{surface area of the ball of the same volume}{actual surface area}$$

As the ball of all bodies of the same volume has the smallest surface area, the denominator in sphericity for all non-balls assumes a greater value than the numerator and therefore the form factor F is less than or equal to 1, wherein a form factor equal to 1 applies only for balls. Circulatory is defined as a analogon in relation to sphericity for example in image evaluation:

$$Circulatory = \frac{periphery of the circle of the same projection area}{actual periphery of the same projection area}$$

Circulatory assumes values of less than or equal to 1 because the periphery of all non-circular areas is larger than that of the circle of the same area.

In accordance with an embodiment of the invention it can be provided that the proportion of the solid particles relative to the proportion of the liquid is between 75% by weight and 98% by weight, preferably between 80% by weight and 95% by weight.

In a possible embodiment it can be provided that the solid particles are of a diameter of between 0.2 μm and 100 μm. However a predetermined grain size distribution of the solid particles has been found to be particularly advantageous, in which respect for example it can be provided that about 80% of the solid particles are of a maximum size of 100 μm and about 20% of the solid particles are of a maximum size of 30 μm. In that way it is particularly easy to produce a dense ball packing so that the intermediate spaces remaining between the solid particles are very small. It can also be provided that—when using non-metallic particles—about 50% of the solid particles are of a diameter of between 10 μm and 100 μm. When using metallic solid particles the diameter can also be smaller.

In an embodiment of the invention it can be provided that the solid particles are formed by particles of differing material. In that case it is possible to use solid particles of ceramic material, glass, metal and/or chalk. When using chalk it may be desirable if the chalk grains are of a diameter which is smaller than 3 μm. It is also advantageously possible to use solid particles of plastic granulate, rock flour, corundum and/or precious or semiprecious stones (for example emerald, ruby, sapphire).

Production of the damping medium can be effected by mixing into an amount of the liquid, which has been previously ascertained in weight, the amount of solid particles which has also been ascertained by weight. Possible monitoring of the composition can be effected so that the diameter of the solid particles included and the frequency with which they occur can be determined by means of a raster electron microscope (REM). In that respect it may be desirable firstly to separate the solid particles and the liquid by means of a centrifugal process.

To carry the invention into effect it may be desirable if the space is arranged between two damping components movable relative to each other in a damping stroke. In an embodiment it is provided that the damping components are arranged rotatably relative to each other. The invention can thus be particularly advantageously implemented in dampers in which at least one of the two damping components performs—preferably exclusively—a rotary movement relative to the other damping component during the damping stroke. Such dampers are frequently also referred to as rotational dampers.

In a preferred embodiment it can be provided that the rotatable damping component is of a substantially wheel-shaped configuration. The space accommodating the damping medium can in that case be formed between a peripheral circumferential surface of the rotatable damping component and an inner surface of the stationary damping component. In that case the wheel-shaped rotatable damping component extends almost to the stationary damping component, forming the space which accommodates the damping medium. In this connection it may be desirable if the space is in the form of a substantially peripherally extending, annular shearing gap.

In a further embodiment of the invention it can be provided that one or also both damping components has or have macroscopic surface elements for increasing their surface or surfaces intended for contact with the damping medium. The surface elements include knobs, grooves, points, teeth, recesses, raised portions or a roughened surface structure. Extensive tests by the applicant have shown that it is advantageous if the surface elements are arranged at the peripheral edge of a rotatable damping component, wherein the relative angular spacing of two adjacent surface elements—with respect to the axis of rotation of the damping component—is between 5° and 20°, preferably between 8° and 15°.

In the simplest case the furniture fitting can be in the form of a fixing element for mounting the damper. In addition the furniture fitting can be in the form of a furniture hinge, a pull-out-guide assembly for drawers or also an actuating mechanism for moving a furniture flap. The damper according to the invention can in that case be so arranged that it damps a relative movement—in particular a linear movement and/or a pivotal movement—of at least two fitment parts to be fixed to a furniture part. In that respect in the case of furniture hinges the relative movement of a hinge cup to hinge arm can be damped, in the case of a pull-out-guide assembly for drawers damping can be in respect of the relative movement of two rails and in the case of an actuating mechanism the pivotal movement of an actuating arm provided for the movement of the furniture flap can be damped. For reasons of simplicity the accompanying Figures show the arrangement of a damper on a furniture hinge. It will be directly apparent to the person skilled in the relevant art by reference to the illustrated embodiments, how the damper is to be arranged on a pull-out-guide assembly for drawers or on an actuating mechanism for the movement of a furniture flap. If a translatory movement of a furniture part or a furniture fitting was to be damped, that translatory movement can be transmitted by way of suitable transmission means (for example by way of a toothed rack and a pinion meshing therewith) to a damper according to the invention which is in the form of a rotational damper.

Further details and advantages of the present invention are described with reference to the specific description hereinafter. In the drawing:

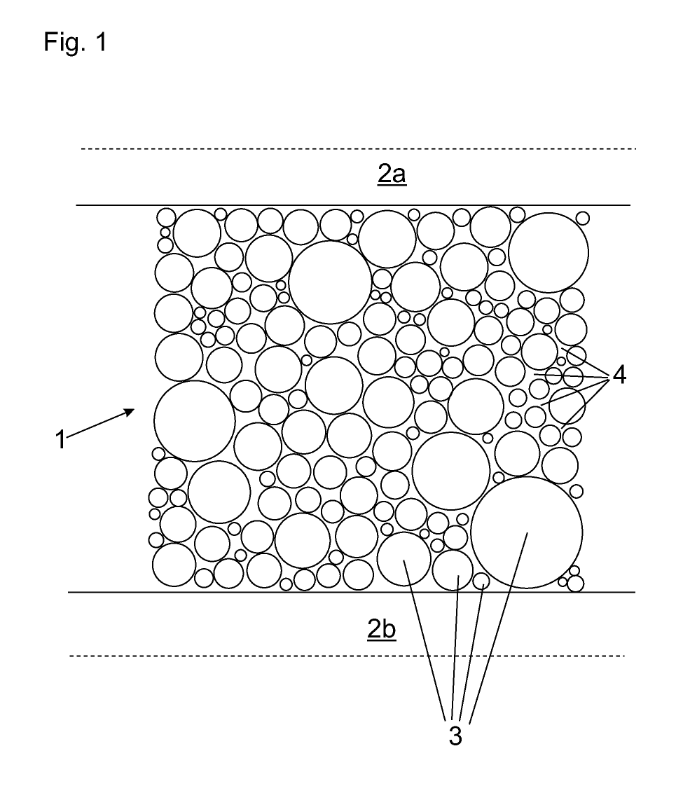

FIG. 1 shows a heavily diagrammatic view of a space provided for accommodating a damping medium of a furniture damper with a damping medium arranged therein,

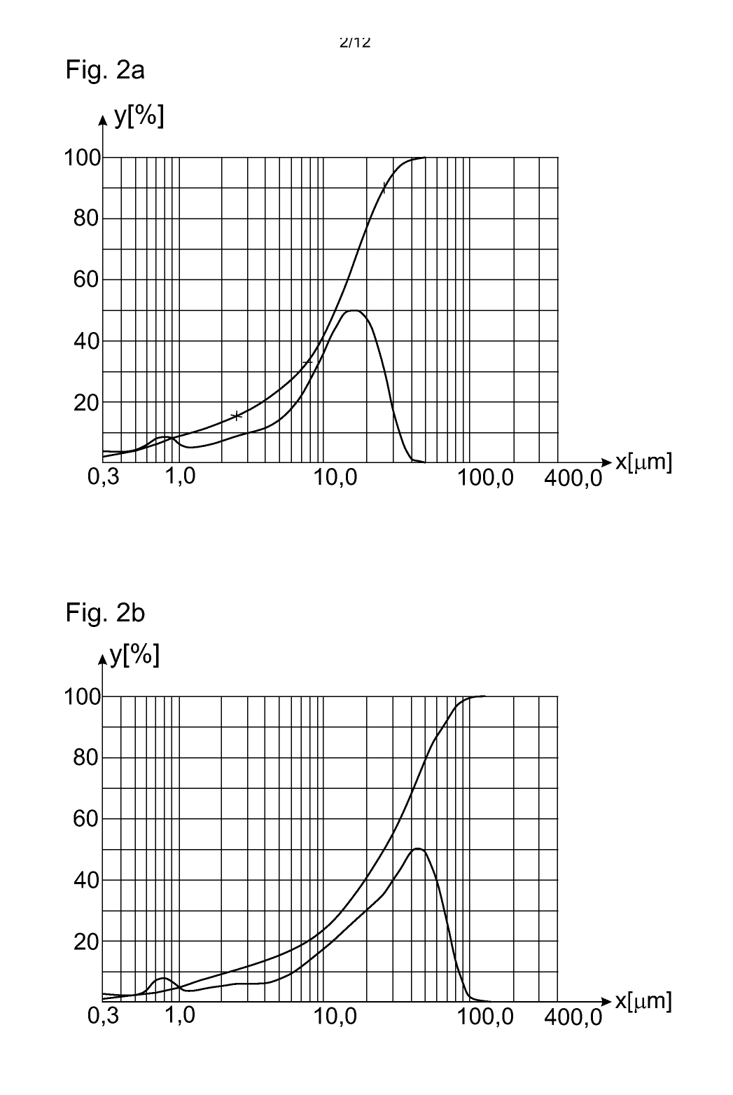

FIGS. 2a, 2b show two different histograms showing different grain size distributions of the solid particles,

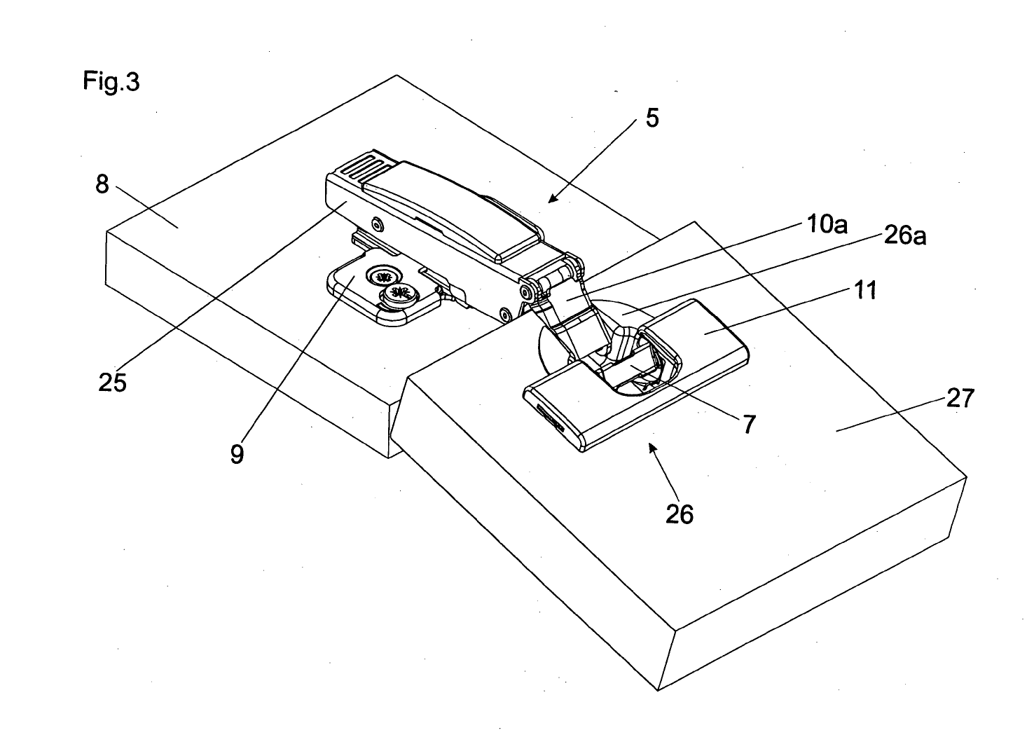

FIG. 3 shows a perspective view of a damped furniture hinge in the mounted condition,

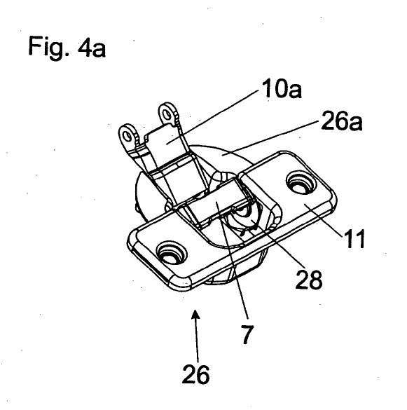

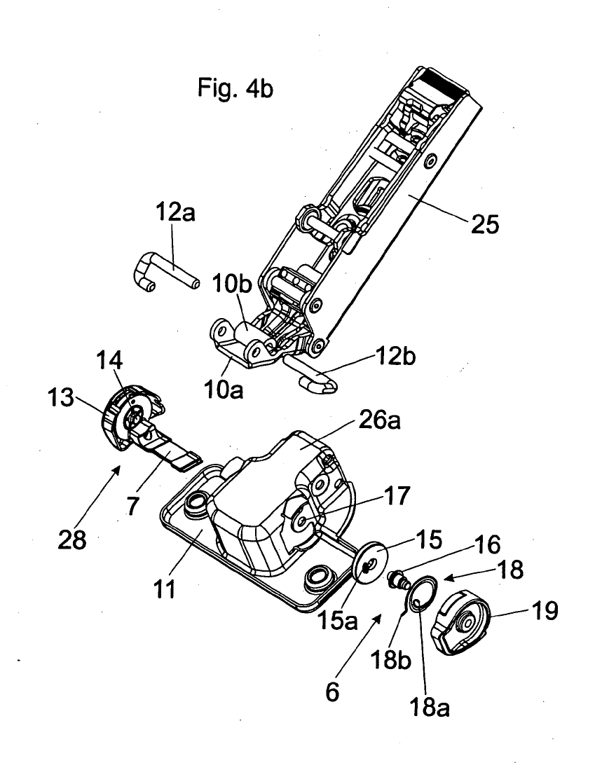

FIGS. 4a, 4b show the hinge cup in the assembled condition and an exploded view of the hinge as a perspective view from below,

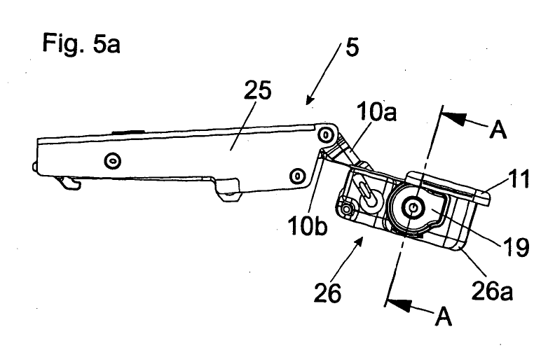

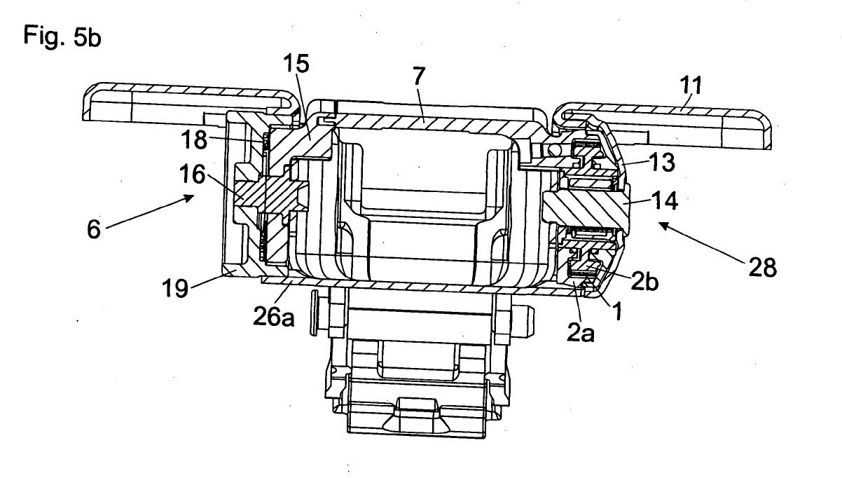

FIGS. 5a, 5b show a sectional view of the hinge and a view on an enlarged scale along section plane A-A in FIG. 5a,

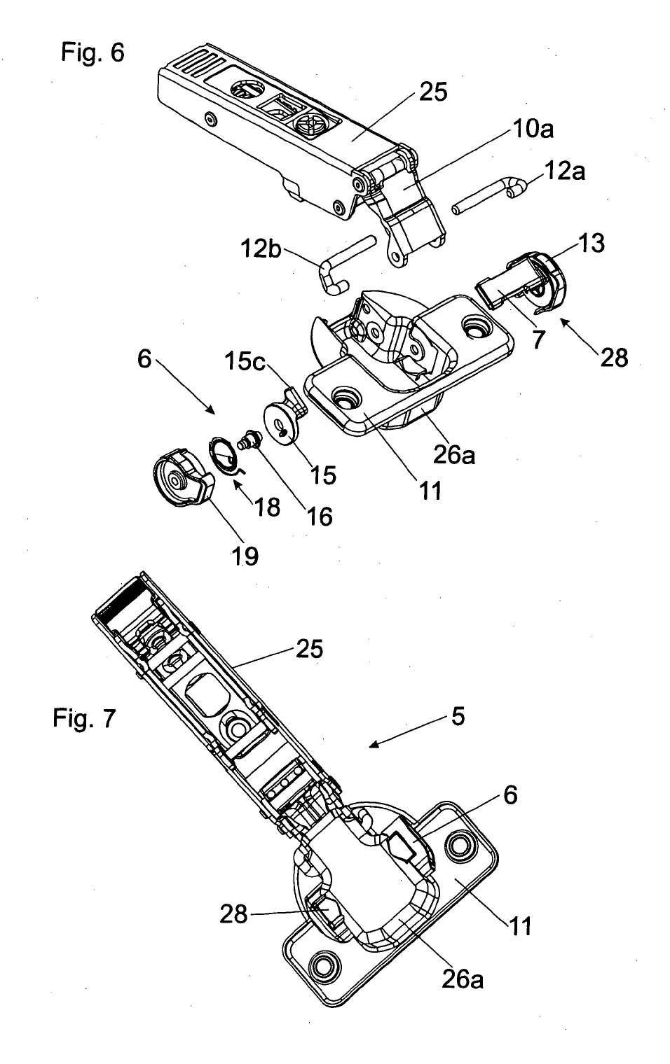

FIG. 6 shows an exploded view of the hinge as a perspective view from the front,

FIG. 7 shows the hinge in the assembled condition as a perspective view from below,

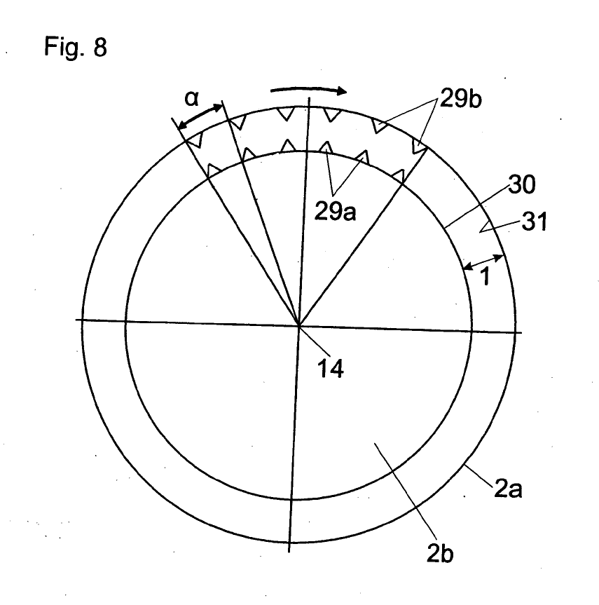

FIG. 8 shows a diagrammatic view of two damping components which are rotatable relative to each other and which are each provided with macroscopic surface elements,

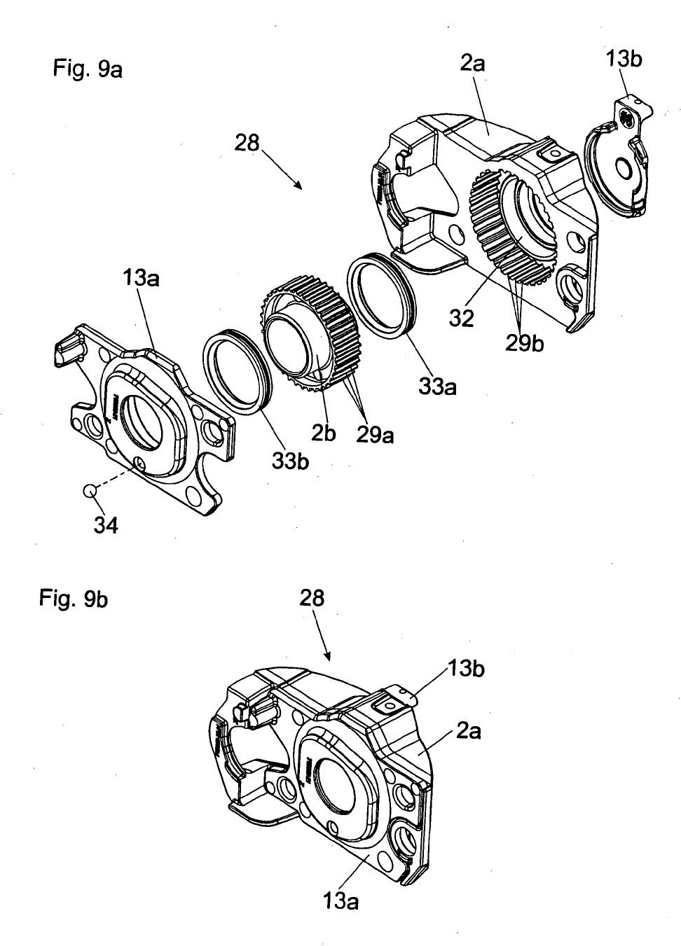

FIGS. 9a, 9b show an exploded view of a damper having two damping components which are rotatable relative to each other and a perspective view of the damper in the assembled condition,

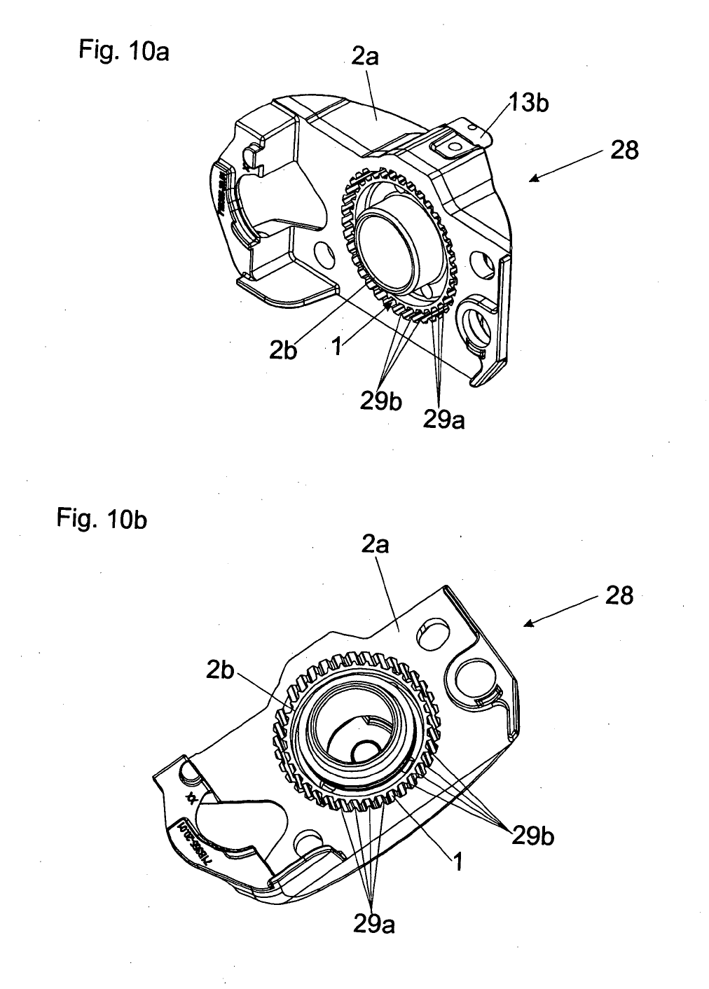

FIGS. 10a, 10b show two different perspective views of the damper, and

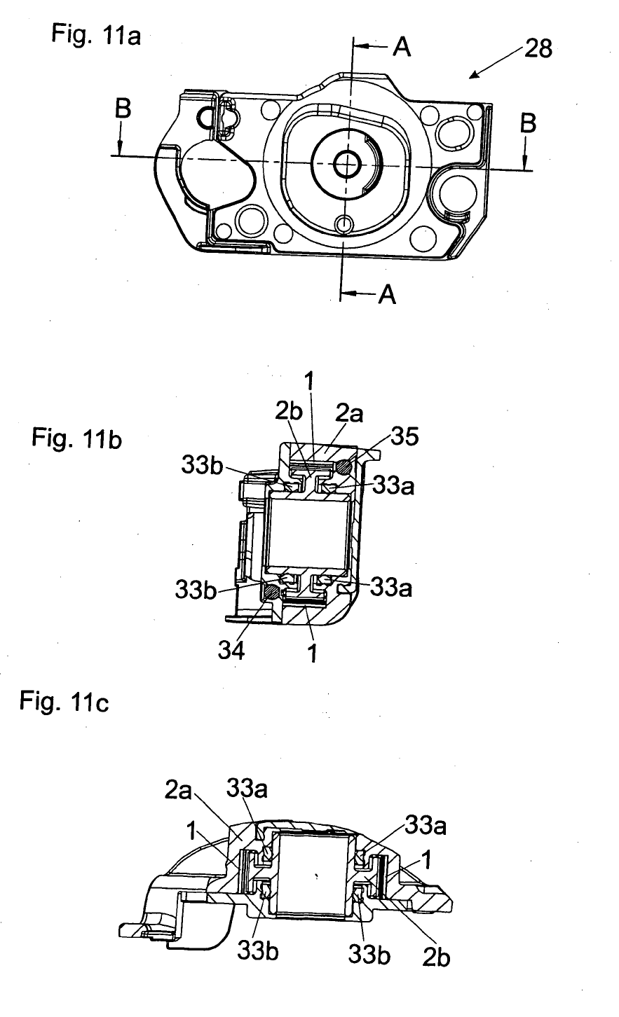

FIGS. 11a-11c show a side view of the damper and views in vertical section and in horizontal section.

FIG. 1 diagrammatically shows a space 1 of a furniture damper, for accommodating a damping medium. The space 1 is formed between a first damping component 2a and a second damping component 2b, wherein the two damping components 2a and 2b are arranged movably relative to each other—as shown in the discussed embodiment preferably rotatably relative to each other—as is the case with so-called rotational dampers. At least one of the two damping components 2a, 2b is drivable by a movement of a movable furniture part (not shown here). Rotation of the first damping component 2a relative to the second damping component 2b (or also vice-versa) means that shearing forces which produce the damping action act on the damping medium arranged in the space 1. The height of the space 1 is preferably selected to be relatively small, for example less than 0.8 mm, preferably less than 0.5 mm. The space 1 can be filled with a damping medium including a multiplicity of solid particles 3 of differing sizes. The solid particles 3 used are of a predetermined grain size distribution so that a relatively high packing density can be afforded by the sizes of the solid particles 3, that differ from each other. The viscosity of the damping medium is also determined by the size of the solid particles 3. The viscosity thus also determines the damping speed of the damper so that the intermediate spaces remaining between the solid particles 3 should not be completely filled by very small particles. To achieve advantageous damping properties, a defined grain size distribution for the solid particles 3 is advantageous. The intermediate spaces 4 remaining between the solid particles 3 are substantially completely filled with a liquid—preferably a synthetic oil. Shearing forces are produced upon a movement, initiated by the damping stroke, between the solid particles 3 and the liquid, wherein the moments in the damping medium are transmitted in the interaction between the liquid and the solid particles 3. In the moved condition the damping medium is just still capable of flow so that a damping action can be generated. The solid particles 3 are spherical or approximately spherical and have a form factor F>0.5, preferably between 0.5 and 1.0. Such solid particles 3 are commercially available, wherein the round shape thereof can be produced by torching (that is to say by the action of heat). The space 1 of the damper is desirably arranged where the largest relative movement (for example the greatest rotary speed) occurs. In the case of a rotational damper therefore it may be desirable for the space 1 to be arranged as far away as possible in relation to the coaxial axis of rotation of the two damping components 2a, 2b. The liquid for filling the intermediate spaces 4 preferably has an ethylene-a-olefin copolymer (for example Lucant® HC-2000 from Mitsui Chemicals Corporation Ltd.). In addition the liquid can be provided with an additive—for example a silicone oil—, wherein the proportion of the silicone oil relative to the total amount of the liquid can be about 20% by weight. By virtue of a substantially spherical configuration for the solid particles 3 they can roll against each other during the damping stroke and scarcely tilt. In the event of a slow movement (that is to say at a low angular speed), that involves hybrid friction due to the liquid arranged between the solid particles 3, whereas in contrast with a higher angular speed the liquid is displaced and damping is produced by solid body friction.

FIG. 2a shows the grain size distribution of the solid particles 3 by reference to a histogram, that is to say a graphic representation of the frequency distribution of the solid particles 3 used plotted against the grain sizes occurring. It is preferably provided that the proportion of the solid particles 3 shown in this diagram is about 15% by weight relative to the total amount of the solid particles 3. The diameter of the solid particles 3 is plotted on the logarithmically scaled x-axis. The frequency of the solid particles 3 is scaled in a percentage form on the y-axis. As a value by way of example it can be seen from this diagram that 50% of the solid particles 3 are of a diameter of less than 20 μm. FIG. 2b shows the grain size distribution of further solid particles 3, wherein the proportion of those solid particles is about 80% relative to the total amount of the solid particles 3. In this respect it can be seen as a value by way of example that 50% of those solid particles 3 are of a diameter of about 50 μm. The total amount of the solid particles 3 is therefore formed from a sum value of the frequency distributions shown in FIG. 2a and FIG. 2b.

FIG. 3 shows a possible embodiment of a hinge 5 with a damping function in the mounted position. In the illustrated embodiment the hinge 5 is adapted to damp a closing movement. Alternatively or additionally it can also be provided that the hinge 5 damps an opening movement of a movable furniture part 27. In per se known manner the hinge 5 has a base plate 9 which is screwed to the furniture carcass 8 and onto which a first fitment portion 25 in the form of a hinge arm can be clipped. In addition the hinge 5 includes an inner hinge lever 10b and an outer hinge lever 10a which hingedly connect the second fitment portion 26 with the hinge cup 26a to the stationary fitment portion 25. The inner hinge lever 10b is concealed in the illustrated view by virtue of its crank configuration. Provided on the movable furniture part 27 is a bore (it cannot be seen here) into which the hinge cup 26a is recessed, as is known per se. In addition, a fixing flange 11 is provided for fixing the hinge cup 26a. It is also possible to see an actuating element 7 which is mounted pivotably within predetermined limits relative to the hinge cup 26a. As from a given relative position of the two fitment portions 25, 26 with respect to each other, the actuating element 7 is acted upon by the outer hinge lever 10a. In that case the actuating element can be pressed completely into the hinge cup 26a in the course of the closing movement of the hinge 5, that movement of the actuating element 7 being transmitted to a damper (not visible here) so that in that way the movement of the actuating element 7 (and therewith the closing movement of the movable furniture part 27 as far as the completely closed position thereof) can be damped.

FIG. 4a shows a perspective view from above illustrating the second fitment portion 26 with the hinge cup 26a and the outer hinge lever 10a which is provided for acting on the rotatably mounted actuating element 7. In a variant it can also be provided that the actuating element 7 can also be acted upon by the hinge arm or the movable furniture part 27. It is possible to see a damper 28 in the form of a rotational damper which is operatively connected to the actuating element 7 at least during the damping stroke and which in the mounted position is fixed to a lateral outside wall of the hinge cup 26a and beneath the fixing flange 11 of the hinge cup 26a.

FIG. 4b shows a perspective view from below of the hinge 5 in an exploded condition. It is possible to see the fitment portion 25, to be fixed to the furniture carcass 8, in the form of the hinge arm which can be releasably latched to the base plate 9 shown in FIG. 3. Mounted on the hinge arm 25 are an outer hinge lever 10a and an inner hinge lever 10b which form a hinged connection to the hinge cup 26a by way of hinge pins 12a, 12b in the assembled position. It is possible to see the damper 28 in the form of a rotational damper including a damper housing 13 and an actuating element 7 in the form of a pivotal lever, mounted at the axis of rotation 14. A unit separate from the damper 28 for the return mechanism 6 is provided at an opposite side wall of the hinge cup 26a. The return mechanism 6 serves to move the actuating element 7 of the damper 28, after damping has been effected, back again into a ready position for the next damping stroke. For that purpose the return mechanism 6 includes a rotatably mounted return mechanism 15 which in the assembled position is connected to the free end of the actuating element 7 of the damper 28. Desirably, a mechanical latching connection, preferably a snap-action connection, is provided for fixing the actuating element 7 to the return element 15. For mounting the return mechanism 6 to the hinge cup 26a there is provided a trunnion 16 which in the assembled condition of the hinge 5 projects into the hole 17 in the hinge cup 26a. A spring device 18 which in the illustrated embodiment is in the form of a torsion spring serves to return the return element 15 (and therewith the actuating element 7) after the damping stroke has occurred. The spring device 18 in the form of the torsion spring includes a first free end 18a engaging a mounting point 15a of the return element 15. The second free end 18b of the spring device 18 is mounted to the stationary return housing 19. In the damping stroke therefore the actuating element 7 of the damper 28 is urged into the hinge cup 26a by the outer hinge lever 10a whereby the return element 15 of the return mechanism 6 is also rotated about the trunnion 16. In the course of that closing movement of the hinge 5 the spring device 18 is also tensioned. When the actuating element 7 is pushed completely into the hinge cup 26a the spring device 18 is thus also loaded to its maximum. When now the actuating element 7 is released by the outer hinge lever 10a the return element 15 (and therewith the actuating element 7) is urged out of the hinge cup 26a again by the energy stored in the spring device so that after damping has occurred the actuating element 7 can again assume a position for the next damping stroke.

FIG. 5a shows a sectional view of the hinge 5 in the assembled condition. It is possible to see the first fitment portion 25 in the form of a hinge arm and the second fitment portion 26 in the form of the hinge cup 26a connected pivotably to the first fitment portion 25 by way of the two hinge levers 10a, 10b. The return housing 19 of the return mechanism 6 is mounted to a lateral outside wall of the hinge cup 26a. FIG. 5b shows a view on an enlarged scale along a plane in the direction of the arrows A-A in FIG. 5a. The upper termination portion is formed by the fixing flange 7 of the hinge cup 26a, wherein the return mechanism 6 is arranged on one side of the hinge cup 26a and the damper 28 is arranged diametrally opposite. The return mechanism 6 includes a stationary return housing 19 and a return element 15 which is mounted rotatably relative to the trunnion 16, in which respect it is possible to see the spring device 18 for the return movement of the return element 15. It is also possible to see the connection between the actuating element 7 and the return element 15. The damper 28 mounted on the other side of the hinge cup 26a includes an axis of rotation 14 which is fixed together with the damper housing 13 non-rotatably to the hinge cup 26a. The actuating element 7 is operatively connected at least at times to a rotatable damping component 2a so that when the actuating element 7 is pushed into the hinge cup 26a the first damping component 2a rotates relative to the second damping component 2b. Provided between the first damping component 2a and the second damping component 2b is an annular space 1 for accommodating the damping medium in question. In that way, the damping medium in the space 1 is subjected to the action of shearing forces causing the damping action. It is to be noted that the illustrated damper 28 is only shown by way of example. In principle the person skilled in the art can use all suitable dampers 28 known to him, in connection with the concept of the invention.

FIG. 6 shows a perspective view from above of an exploded view of the hinge 5, similar to FIG. 4b. A particularity in this respect is the latching portion 15c which can provide for a snap-action connection between the return element 15 and the actuating element 7 of the damper 28. The actuating element 7 can be at least partially formed from a metallic material, thereby ensuring precise transmission of force between the actuating element 7 and the damper 28 and between the return mechanism 6 and the actuating element 7.

FIG. 7 shows a perspective view from below of the hinge 5, showing the two separate components of the damper 28 and the return mechanism 6. The hinge cup 26a can be fitted together with the two laterally arranged units in a bore which is circular on the movable furniture part 27.

FIG. 8 diagrammatically shows the two damping components 2a, 2b which are mounted rotatably relative to each other about a common axis of rotation 14. It can be seen that the two damping components 2a, 2b have macroscopic surface elements 29a, 29b to increase their surface area intended for contact with the damping medium. By way of example it can be provided that the surface elements 29a, 29b have knobs, grooves, points, teeth, recesses, raised portions and/or a roughened surface structure. In a preferred embodiment of the invention it can be provided that the surface elements 29a are arranged at the peripheral edge of the rotatable damping component 2b, in which case the relative angular spacing a of two adjacent surface elements 29a—with respect to the axis of rotation 14 of the damping component 2b—is between 5° and 20°, preferably between 8° and 15°. It is to be noted that the shape and size of the macroscopic surface elements 29a, 29b has a substantial influence on the closing speed of the damper 28. It may also be desirable to provide the same number, shape and size of the macroscopic surface elements 29a, 29b on the inner damping component 2b and on the outer damping component 2a. At higher damper speeds the adaptation in respect of time of the moment trails the change in the shearing rate, which is due to the elastic component of the viscoelastic damper medium. It is possible to use that effect by virtue of the arrangement of the macroscopic surface elements 29a, 29b which portion-wise reduce the flow cross-section of the damping medium in the space 1. Before therefore the moment can markedly “ease”, the damping medium passes the closest flow cross-section reduced by the surface elements 29a, 29b, whereby an advantageous additional damping effect can be generated.

The macroscopic surface elements 29a are only diagrammatically illustrated, they are preferably distributed around the entire peripheral edge 30 of the inner damping component 2b while the macroscopic surface elements 29b are also arranged peripherally at the inside surface 31 of the outer damping component 2a. The space 1 is formed between a peripheral circumferential edge 30 of the inner damping component 2b and an inside surface 31 of the outer damping component 2a. The toothed configuration formed by the macroscopic surface elements 29a, 29b preferably acts in the emotion region, that is to say in the phase in which the movable furniture part 5, 27 or the furniture fitting parts 25, 26 are immediately before the completely closed position (annular speed for example less than or equal to 5°/s). In contrast at high angular speeds the function of the damper is also possible without those toothed arrangements. The number of teeth of the inner and outer tooth arrangements affords an “excitation frequency”, the torque is controllable by the tooth height, while easing of the torque can also be brought about at low rotary speeds. At high angular speeds the medium acts almost exclusively in the space 1 between the tooth tips of the inner damping component 2b and the tooth tips of the preferably stationary outer damping component 2a (throttle effect). At low angular speeds in contrast the damping medium can penetrate into the depths of the teeth, whereby it is possible to provide a different damping characteristic. The ratio of the number of macroscopic surface elements 29a arranged on the rotatable damping component 2b in relation to the number of macroscopic surface elements 29b can be fixed at 1:1 although a ratio differing therefrom is also possible.

FIG. 9a shows an exploded view of the damper 28 with an outer damping component 2a having a substantially cylindrical hollow space 32 for accommodating the rotatable damping component 2b. It is also possible to see the macroscopic surface elements 29b in the form of tooth arrangements, which are provided in peripherally extending relationship at the circumferential surface of the hollow space 32. In the mounted condition the inner damping component 2a is fitted in the hollow space 32. In the illustrated embodiment the rotatable damping component 2b is of a substantially wheel-shaped configuration and also has macroscopic surface elements 29a in the form of tooth arrangements. The wheel-shaped damping component 2b is drivable by the actuating element 7 shown in FIG. 6. In this case there can also be provided a freewheel (not shown here), wherein the damping components 2a, 2b between which the damping medium acts or is arranged can remain in their relative position with respect to each other during the return stroke. The freewheel permits a return stroke by virtue of the spring 18 shown in FIG. 6 without the damping components 2a, 2b of the damper 28 having to be moved relative to each other for that purpose. It is possible to see sealing rings 33a and 33b and the damper housing portions 13a and 13b connected to the outer damping component 2a. The housing portion 13a has a filling opening for the damping medium which is closable by a closure element 34 in the form of a ball. FIG. 9b shows the damper 28 in the assembled condition.

FIG. 10 shows the view of FIG. 9b, wherein the damper housing portion 13a has been omitted for the sake of enhanced clarity. The substantially wheel-shaped damping component 2b extends almost to the outer damping component 2a. The space 1 for accommodating the damping medium is in the form of an annular gap completely extending around the inner damping component 2b in the illustrated embodiment, wherein the damping action of the damper 28 is based—preferably substantially exclusively—on a shearing action. The space 1 in the form of the annular gap extends approximately in an annular configuration in an orthogonal direction with respect to the axis of rotation 14 of the inner damping component 2b.

FIG. 11a shows a side view of the damper 28 while FIG. 11b shows a vertical section along plane A-A in FIG. 11a. It is possible to see the damping component 2b mounted rotatably within the stationary damping component 2a and the space 1 therebetween for accommodating the damping medium. To prevent the damping medium from escaping, the arrangement has flanking sealing rings 33a and 33b. When filling the damping medium it is heated and then injected into the space 1 in the form of a shearing gap. For uniform filling of the damper 28 there is a venting ball 35 which allows the volume of air displaced in the filling operation to escape. To close the damper 28 there is a closure element 34 in the form of the ball. FIG. 11c shows a horizontal section along plane B-B in FIG. 11a.

The present invention is not limited to the illustrated embodiments by way of example but embraces or extends to all variants and technical equivalents which can fall within the scope of the accompanying claims. The damper 28 described in the Figures and the illustrated return mechanism 6 are only to be interpreted as possible embodiments, on the basis of which the invention has been described.

1. A furniture fitting comprising a damper, the damper has a space for accommodating a damping medium, wherein the space is substantially completely filled with a multiplicity of solid particles, wherein the intermediate spaces remaining between the solid particles are substantially completely filled by a liquid.

2. The furniture fitting according to claim 1, wherein the solid particles are of a substantially spherical configuration.

3. The furniture fitting according to claim 1, wherein the proportion of the solid particles relative to the proportion of the liquid is between 75% by weight and 98% by weight.

4. The furniture hinge according to claim 3, wherein the proportion of the solid particles relative to the proportion of the liquid is between 80% by weight and 95% by weight.

5. The furniture fitting according to claim 1, wherein the solid particles are of a diameter of between 0.2 μm and 100 μm.

6. The furniture fitting according to claim 1, wherein the solid particles have a predetermined grain size distribution, wherein about 80% of the solid particles are of a maximum size of 100 μm and about 20% of the solid particles are of a maximum size of 30 μm.

7. The furniture fitting according to claim 1, wherein about 50% of the solid particles are of a diameter of between 10 μm and 100 μm.

8. The furniture fitting according to claim 1, wherein the solid particles are formed by particles of differing material.

9. The furniture fitting according to claim 1, wherein the viscosity index of the liquid is greater than 150.

10. The furniture fitting according to claim 1, wherein the liquid has a polymer.

11. The furniture fitting according to claim 10, wherein the polymer is an ethylene-α-olefin copolymer.

12. The furniture fitting according to claim 1, wherein the liquid comprises an oil.

13. The furniture fitting according to claim 12, wherein the oil is a silicone oil.

14. The furniture fitting according to claim 13, wherein the proportion of silicone oil to the total amount of the liquid is at a maximum 9%.

15. The furniture fitting according to claim 1, wherein the space is arranged between two damping components movable relative to each other in a damping stroke.

16. The furniture fitting according to claim 15, wherein the damping components are arranged rotatably relative to each other.

17. The furniture fitting according to claim 15, wherein at least one damping component has macroscopic surface elements to enlarge its surface intended for contact with the damping medium.

18. The furniture fitting according to claim 17, wherein both damping components have macroscopic surface elements.

19. The furniture fitting according to claim 17, wherein the surface elements include knobs, grooves, points, teeth, recesses, raised portions or a roughened surface structure.

20. The furniture fitting according to according to claim 17, wherein the surface elements are arranged at the peripheral edge of a rotatable damping component, wherein a relative angular spacing of two adjacent surface elements—with respect to the axis of rotation of the damping component—is between 5° and 20° or between 8° and 15°.

21. The furniture fitting according to claim 15, wherein a rotatable damping component is of a substantially wheel-shaped configuration.

22. The furniture fitting according to claim 15, wherein the space is formed between a peripheral circumferential surface of the rotatable damping component and an inner surface of the other damping component.

23. The furniture fitting according to claim 15, wherein one damping component extends almost to the other damping component.

24. The furniture fitting according to claim 1, wherein the space is in the form of a substantially peripherally extending, annular shearing gap.

25. The furniture fitting according to claim 1, wherein the furniture fitting is in the form of a furniture hinge, a pull-out-guide assembly for drawers or an actuating mechanism for moving a furniture flap.
